(19) United States
(12) Patent Application Publication
(10) Pub. No.: US 2006/0103551 A1
(43) Pub. Date: May 18, 2006

(54) System and method for tracking a mobile unit with a GPS system

(75) Inventors: Shih-Hsiung Weng, Taipei (TW); Eng-Beng Ng, Bayan Lepas (MY)

Correspondence Address: Welsh & Katz, Ltd.;Eric D. Cohen, 22nd Floor, 120 South Riverside Plaza, Chicago, IL, 60606, US

(73) Assignee: Inventec Multimedia & Telecom Corporation, Taipei (TW)

(21) Appl. No.: 10/980,593

(22) Filed: Nov. 3, 2004

(51) Int. Cl. G08G 1/123; G01C 21/28; G08B 1/08

(52) U.S. Cl. 340/988; 340/539.13; 701/213

(57) ABSTRACT

A system and method for tracking a mobile unit with a GPS system is provided. The system obtains the position data of the mobile unit by communication between the mobile unit and at least three GPS satellites. Then, the position data is transmitted to the master control station through a local area satellite and stored in the master control station. The PVR user only needs to transmit the ID of the mobile unit to the master control station through a communication network. Then, the master control station transmits the position data of the mobile unit to the PVR and shows an E-map on the television screen, to show the user where the mobile unit is.

### FIELD OF THE INVENTION

The invention relates to a system and method for tracking a mobile unit, and particularly to a system and method for tracking a mobile unit with a GPS system.

### BACKGROUND OF THE INVENTION

The GPS system (Global Positioning system) was developed by the U.S. Department of Defense for military demands. However, because the GPS system has the advantages of navigation and global positioning, it has been widely used in non-governmental circles.

The GPS system consists of 24 satellites (21 active satellites and 3 supplemental satellites). The satellites are located in orbit 10600 miles above earth's horizon, and four of them are located on the horizon. Each satellite comprises a computer, an atomic clock, and a wireless communication device. The satellites detect their orbits and clock, and continuously send radio signals to inform their change of position and time. Also, the satellites send signals to a master control station in order to correct their position and time every day.

In contrast to the satellites, the GPS receivers receive three GPS satellite signals from any three satellites on the horizon to compute the positions in three directions. The error is limited to 100 meters. If the GPS transceiver can receive the GPS satellite signals from the fourth satellite on the horizon, the altitude of a subject will also be obtained.

Generally speaking, a traveler uses a mobile phone to communicate with his or her family. Because communication technology is well developed, the mobile phone has become a very convenient means to communicate. But when the traveler is in a remote district in which the mobile phone cannot receive signals, the family will lose contact with the traveler.

For this reason, a communication device and method thereof used in remote districts to replace the mobile phone is of great urgency. A user-friendly interface is also important.

### SUMMARY OF THE INVENTION

The object of the invention is to provide a system and the method for tracking a mobile unit with the GPS system. The system cooperates with the GPS system to display an E-map on a PVR. The E-map shows where the mobile unit is and provides this information to the PVR user.

The system for tracking the mobile unit with the GPS system comprises a PVR, a communication network, a master control station, at least one mobile unit, at least one transceiver, a plurality of GPS satellites, and a local area satellite.

When the mobile unit starts, the mobile unit transmits pseudo random code signals constantly. The GPS satellites receive and process the pseudo random code signals. Then, the GPS satellites transmit the pseudo random code signals to the mobile unit. When the mobile unit receives the signals from at least three GPS satellites, we can get the information of the altitude, the longitude, and the altitude of the mobile unit. The accuracy depends on the number of GPS satellites from which the pseudo random code signals are transmitted.

Next, the mobile unit transmits its position data to the local area satellite through the transceiver. Then, the local area satellite transmits the position data to the master control station. The position data is stored in a database of the master control station. The PVR transmits a request signal with an ID of the mobile unit to the master control station through the communication network. The master control station checks whether the position data of the mobile unit is stored in the database. Finally, the master control station transmits the position data of the mobile unit to the PVR.

According to the above description, the invention has the following advantages:
1. The user only needs to connect the PVR with the communication network in order to obtain the position data of the mobile unit. So, they don't have to worry whether the mobile unit can receive cell phone signals or not.
2. The user can help the mobile unit arrive at his/her destination with the invention.
3. Users and/or police can track stolen cars with the invention.
4. The user can know where the mobile unit is with the assistance of the E-map.
5. The user can know the position and safety of the mobile unit. In addition, the cost of the invention is less than the prior art.
6. When the user tracks the position of the mobile unit, he/she can watch TV at the same time.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a system structure of the preferred embodiment of the invention;

FIG. 2 is a system structure of the PVR;

FIG. 3 is a system structure of the mobile unit;

FIG. 4 is an operation flow chart of the PVR;

FIG. 5 is an operation flow chart for identifying the ID of the mobile unit;

FIG. 6 is a flow chart of obtaining the position data of the mobile unit;

FIG. 7 is a welcome screen when starting the tracking function of the GPS;

FIG. 8 is a snap screen when the PVR requests to connect with the master control station;

FIG. 9 is a snap screen when the PVR is connecting with the master control station;

FIG. 10 is a snap screen for asking the user to enter the ID of the desired mobile unit;

FIG. 11 is a snap screen for identifying the ID of the mobile unit;

FIG. 12 is a snap screen for informing the user to wait until all the related data is downloaded from the master control station;

FIG. 13 is a snap screen showing the E-map with the mobile unit;

FIG. 14 is a snap screen showing the detailed information of the mobile unit; and

FIG. 15 is a snap screen for asking the user to provide related information in order to connect with the master control station.

### DETAILED DESCRIPTION OF THE INVENTION

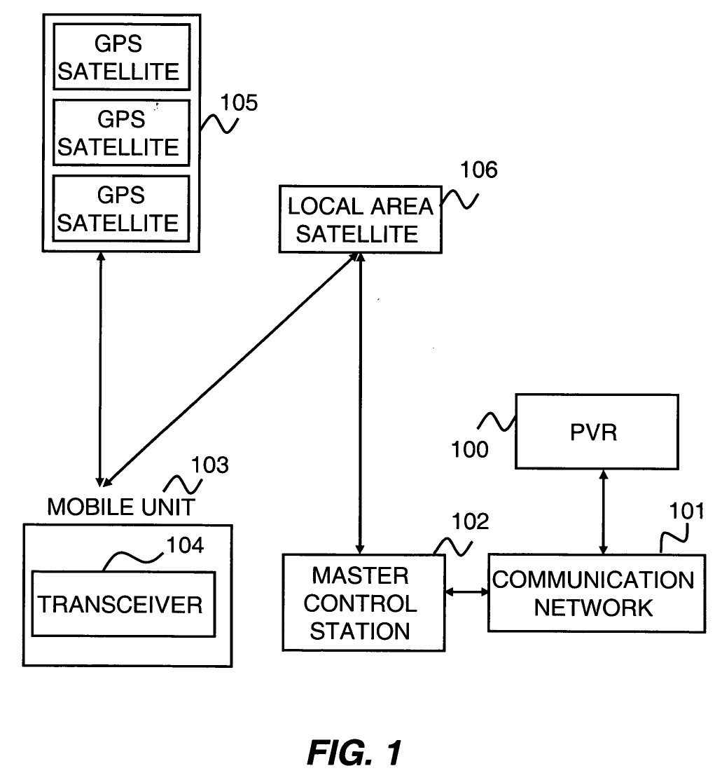

The system structure of the preferred embodiment of the invention is illustrated in FIG. 1. The system includes a PVR 100, a communication network 101, a master control station 102, at least one mobile unit 103, at least one transceiver 104, a plurality of GPS satellites 105, and a local area satellite 106.

The PVR 100 shows the position of the mobile unit 103. The communication network 101 transmits signals between the PVR 100 and the master control station 102. The communication network 101 can be a satellite communication network, an integrated services digital network (ISDN), a digital subscriber line, and so on.

The master control station 102 obtains the position data of all of the mobile units 103 and transmits the related information to the user according to the entered ID of the mobile unit 103. The master control station 102 also edits and updates the E-map for the PVR 100.

The mobile unit 103 connects with a moving body for navigation, investigation, and tracking. The mobile unit 103 can be located in a black box to avoid moisture and damage. The transceiver 104 is set in the mobile unit 103 for receiving and transmitting signals.

The GPS satellites 105 provide the position data for the mobile unit 103.

The local area satellite 106 like the MEASAT works as a communication media between the mobile unit 103 and the master control station 102.

When the mobile unit 103 starts, the mobile unit 103 transmits pseudo random code signals constantly. The GPS satellites 105 process the received pseudo random code signals and then transmit the pseudo random code signals to the mobile unit 103. When the mobile unit 103 receives the signals from at least three GPS satellites, the information of the altitude, the longitude, and the altitude of the mobile unit can be obtained. The position data can be obtained from the altitude, the longitude, and the altitude of the mobile unit. The accuracy depends on the number of the GPS satellites from which the pseudo random code signals are transmitted.

The mobile unit 103 transmits its position data to the local area satellite 106 through the transceiver 104. Then, the position data is transmitted to the master control station 102 and stored in a database for update.

At this time, the PVR 100 transmits a request command with the ID of the desired mobile unit to the master control station 102. The master control station 102 identifies whether the position data of the desired mobile unit is stored in the database according to the ID. Then, the position data of the mobile unit 103 is transmitted to the PVR 100 through the communication network 101.

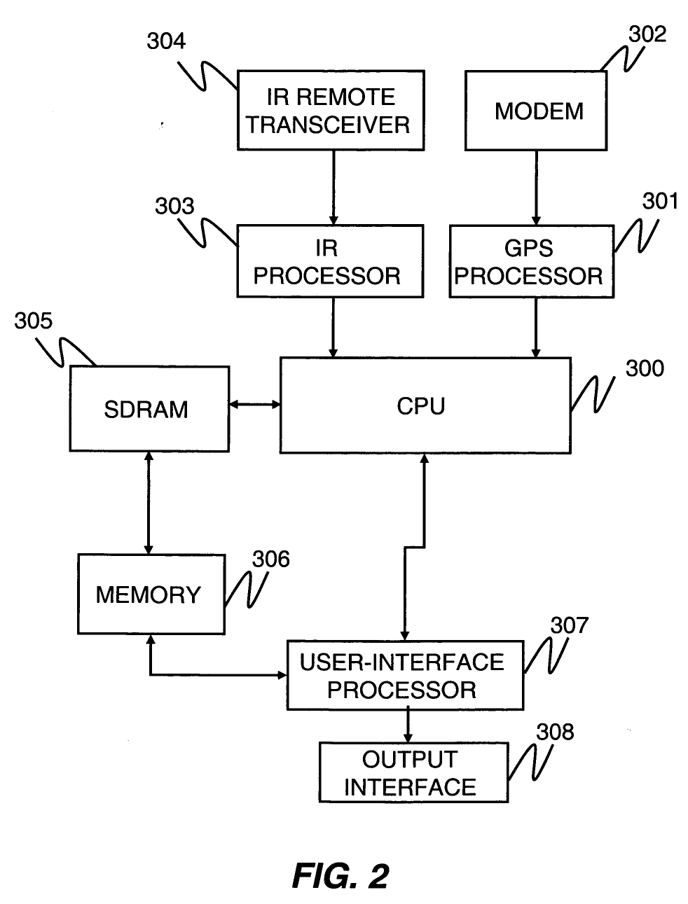

Please refer to FIG. 2, which illustrate the system structure of the PVR 100. The PVR 100 comprises a CPU 300, a GPS processor 301, a modem 302, an IR processor 303, an IR remote transceiver 304, a SDRAM (synchronous dynamic random access memory) 305, a memory 306, a user-interface processor 307, and an output interface 308.

The CPU 300 monitors and processes signals of the PVR 100, such as the image signals and the data signals.

The SDRAM 305 stores temporary commands when the CPU 300 compiles related programs.

The memory 306 is an accessible and erasable hard disk for storing programs and IDs of a plurality of mobile units.

The GPS processor 301 processes the signals with special protocols from the master control station 102, such as the protocol defined by the NMEA (National Marine Electronics Association).

The modem 302 modulates the input signals and demodulates the output signals.

The user-interface processor 307 shows a menu with different functions of the CPU 300.

The output interface 308, such as a TV, outputs the image signals.

The IR remote transceiver 304 receives the control signals from a remote controller.

The IR processor 303 processes the control signals received by the transceiver 304 and transmits a signal to the CPU. The signal is processed by the CPU.

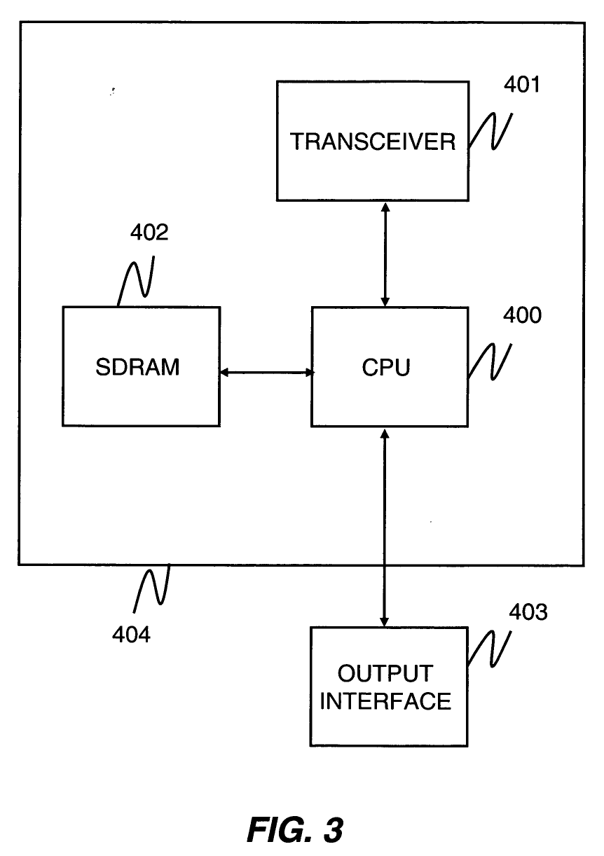

Please refer to FIG. 3, which illustrates the system structure of the mobile unit 103. The mobile unit 103 is located in a black box 404 to avoid collision and damage. The mobile unit 103 comprises a CPU 400, a transceiver 401, an SDRAM 402, and an output interface 403.

The CPU 400 works as the GPS processor 301 and processes signals with a special protocol received by the transceiver 41. The CPU 400 compiles the pseudo random code signals transmitted from the GPS satellites 105 into signals with a special protocol, such as the NMEA, and transmits the signals to the master control station 102 through the transceiver 401.

The transceiver 401 receives and transmits the signals to the GPS satellites 105 and the local area satellite 106.

The SDRAM 402 works as the memory 306, to store programs and the IDs of the mobile units. Because of its small dimensions and portability, the SDRAM 402 can be located in the black box 404.

The output interface 403 connects to the outside of the black box 404 through a port (such as a USB port), to show the information about the mobile unit in non-picture form.

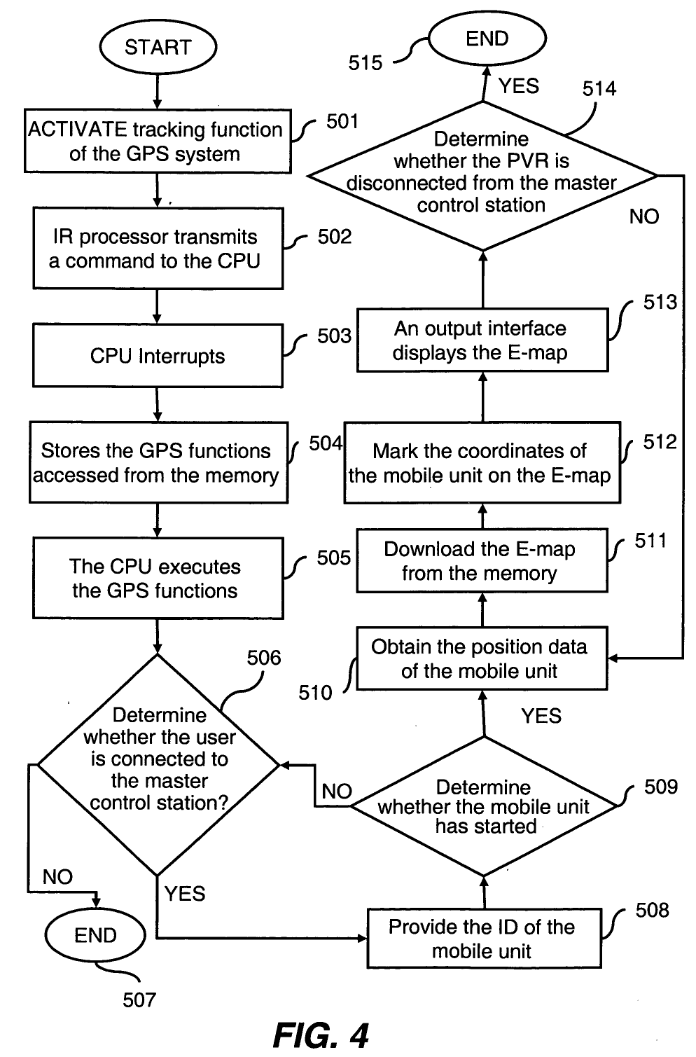

Please refer to FIG. 4, which shows the operation procedure of the PVR 100.

First, the user starts the tracking function of the GPS system (step 501). The user pushes a specific button on the controller to transmit a starting signal to the IR receiver 304 of the PVR 100.

Next, the IR processor transmits a command to the CPU (step 502). After the IR processor 303 receives the starting signal through the IR receiver 304, the IR processor 303 transmits an interrupt command and a command to the CPU 300 in order.

The CPU interrupts its original procedure (step 503). The CPU 300 breaks off the processing procedure and executes the command from the IR processor 303.

The SDRAM stores the GPS functions accessed from the memory (step 504). The CPU 300 transmits a command to store the GPS functions, which are accessed from the memory 306, in the SDRAM 305.

The CPU executes the GPS functions (step 505).

Determine whether the user is connected to the master control station (step 506). The program asks whether the user's PVR is connected to the master control station, to obtain the related information of the mobile unit. If the answer is no, the program terminates.

Provide the ID of the mobile unit (step 508). The user enters the ID of the desired mobile unit to the master control station 102 through the PVR 100.

Determine whether the mobile unit has started (step 509). The master control station 102 determines whether the ID of the mobile unit is stored in the database. If the answer is no, the master control station 102 determines whether the PVR is connected to the master control station 102 (step 506).

Obtain the position data of the mobile unit (step 510). After identifying that the mobile unit 103 has started, the position data of the mobile unit 103 is downloaded to the PVR 100 from the master control station 102.

Download the E-map from the memory (step 511). The PVR 100 downloads an appropriate E-map from the memory 306 according to the position data of the mobile unit 103.

Mark the coordinates of the mobile unit on the E-map (step 512).

An output interface displays the E-map (step 513). The output interface 308 displays the E-map with the coordinates of the mobile unit 103.

Determine whether the PVR is disconnected from the master control station (step 514). The master control station 102 determines whether the PVR 100 has lost contact with the master control station 102. If the answer is yes, the program terminates (step 515). Otherwise, the PVR 100 again obtains the position data of the mobile unit 103 (step 510).

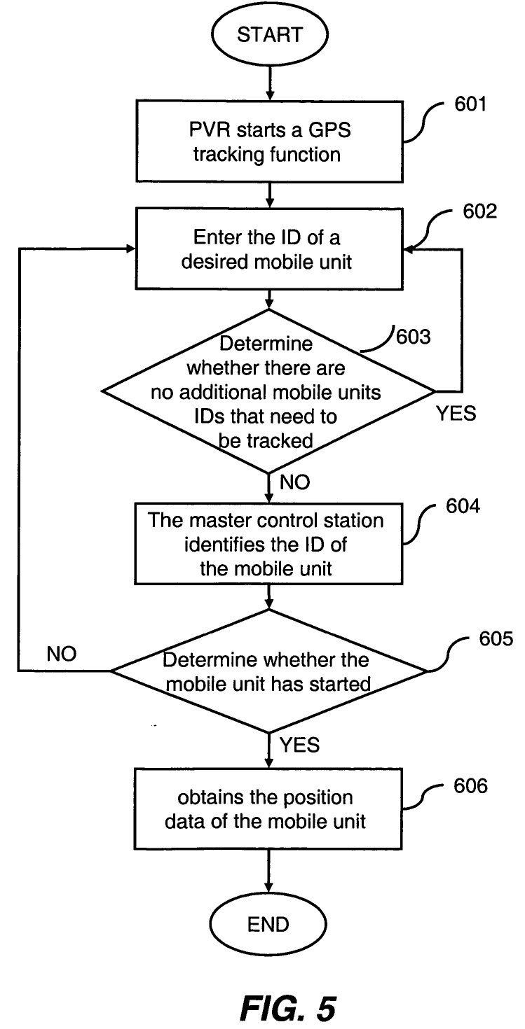

Please refer to FIG. 5, which shows the operation procedure for identifying the ID of the mobile unit.

First, the PVR starts a GPS tracking function (step 601).

Enter the ID of a desired mobile unit (step 602). The user enters the ID of the desired mobile unit 103 by means of a number pad.

Determine whether there are no additional mobile units IDs that need to be tracked (step 603). The master control station 102 determines whether the user wants to track other mobile units. If the answer is yes, the procedure returns to step 602.

The master control station identifies the ID of the mobile unit (step 604).

The master control station determines whether the mobile unit has started (step 605). If the answer is no, the procedure returns to step 602.

The master control station obtains the position data of the mobile unit (step 606).

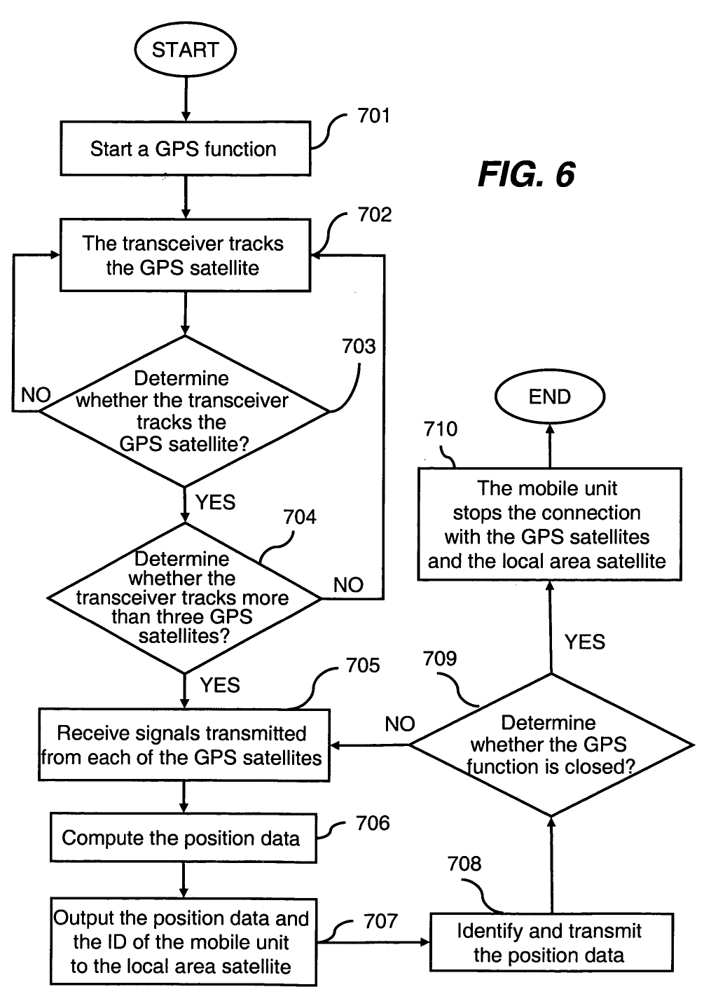

Please refer to FIG. 6, which shows the flow chart of obtaining the position data of the mobile unit.

First, start a GPS function (step 701). The user of the mobile unit starts the GPS function for obtaining the position data.

The transceiver tracks the GPS satellite (step 702). The transceiver transmits a request signal to track the GPS satellite 105. The signal frequency is about 2.2275 GHz.

Determine whether the transceiver tracks the GPS satellite (step 703). If the transceiver does not track any GPS satellite 105, the procedure returns to step 702.

Determine whether the transceiver tracks more than three GPS satellites (step 704). If the transceiver does not track more than three GPS satellites 105, the procedure returns to step 702.

Receive signals transmitted from each of the GPS satellites (step 705). The transceiver 401 receives the signals transmitted from each of the GPS satellites 105.

Compute the position data (step 706). The position data of the mobile unit 103 is computed by the signals transmitted from the GPS satellites 105.

Output the position data and the ID of the mobile unit to the local area satellite (step 707).

Identify and transmit the position data (step 708). When the local area satellite identifies that the signal belongs to the position data, then it transmits the position data to the master control station 102.

Determine whether the GPS function is closed (step 709). If the answer is no, the procedure returns to step 705.

The mobile unit stops the connection with the GPS satellites 105 and the local area satellite (step 710).

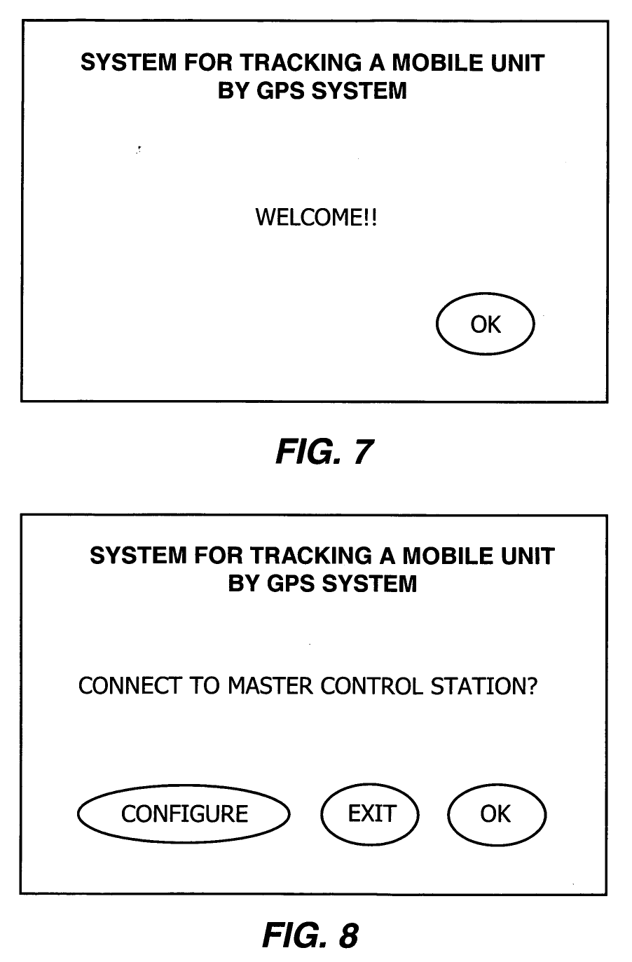

The snap screens of the output interface are illustrated in FIGS. 7 to 15. The “OK” icon allows the user to confirm the functions and enter the next screen. The “leave” icon allows the user to leave the current function and return to the normal mode.

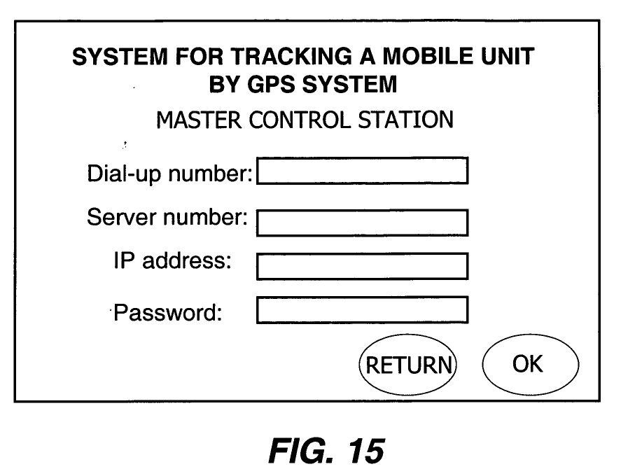

FIG. 7 shows a welcome screen when starting the tracking function of the GPS. FIG. 8 shows the screen when the PVR requests to connect with the master control station. The “CONFIGURE” icon allows the user to jump to the screen illustrated in FIG. 15.

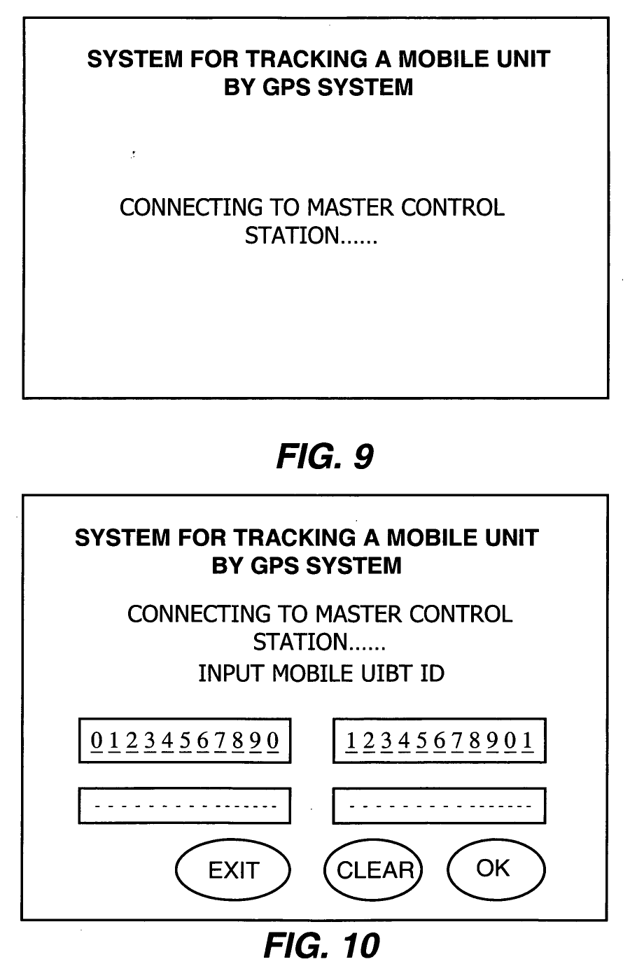

FIG. 9 shows the screen when the PVR is connecting with the master control station.

FIG. 10 shows the screen for asking the user to enter the ID of the desired mobile unit. The “delete” icon is for deleting an unwanted ID.

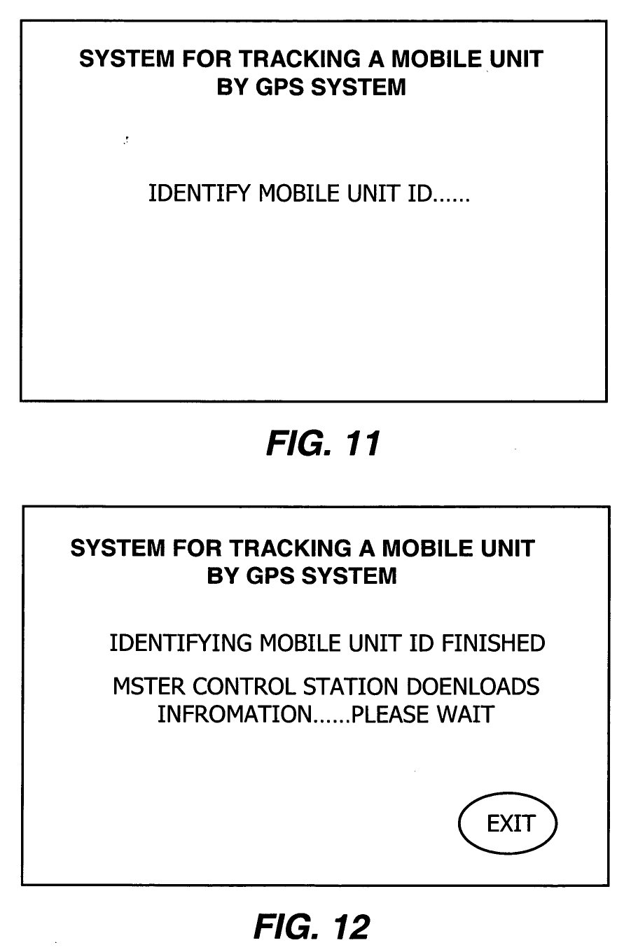

FIG. 11 shows the screen for identifying the ID of the mobile unit. FIG. 12 shows the screen for informing the user to wait until all the related data is downloaded from the master control station.

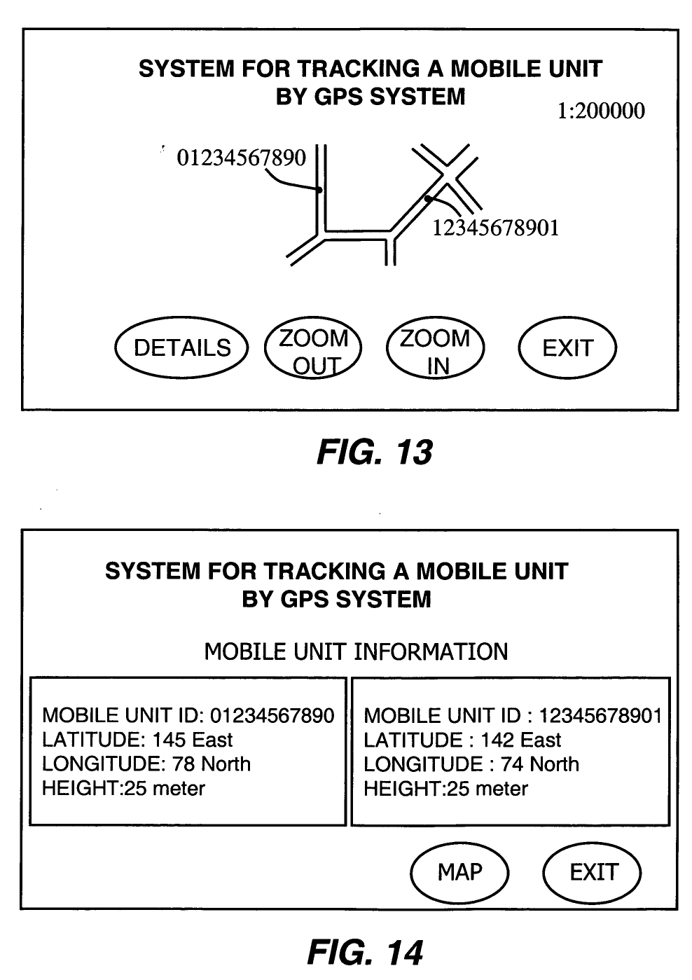

FIG. 13 shows the E-map with the mobile unit. The “zoom in” and “zoom out” icons are used to reduce or enlarge the image size. The “detailed information” icon is used to show the detailed information of the mobile unit as shown in FIG. 14. FIG. 15 shows a screen for asking the user to provide the related information in order to connect with the master control station. The “return” icon allows the user to return to the last screen.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A GPS system, comprising:
a plurality of GPS satellites;
a local area satellite;
at least one mobile unit, including a transceiver for identifying the position of the mobile unit by the communication between the transceiver and the GPS satellites and for transmitting the position data of the mobile unit to the local area satellite;
a master control station, for receiving the position data of the mobile unit from the local area satellite; and
a PVR, which transmits a request command with the ID of the mobile unit to the master control station and shows the position of the mobile unit received from the master control station after the master control station identifies the position with the ID of the mobile unit.

2. The GPS system of claim 1, wherein the PVR and the master control station being connected by a communication network.

3. The GPS system of claim 2, wherein the communication network is a satellite communication network.

4. The GPS system of claim 2, wherein the communication network is an integrated services digital network (ISDN).

5. The GPS system of claim 2, wherein the communication network is a digital subscriber line.

6. The GPS system of claim 1, wherein the mobile unit is located in a black box to avoid the moisture and damage.

7. The GPS system of claim 1, where in the mobile unit comprising:
a transceiver, for receiving and transmitting signals to the GPS satellites and the local area satellite;
a CPU, for processing and compiling the signals with special protocol received by the transceiver from the master control station, then transmitting the signals to the master control station constantly through the transceiver;
a SDRAM, for storing a program and the IDs of the mobile units; and
an output interface, for showing information about the mobile unit.

8. The GPS system of claim 1, wherein the master control station is for editing and updating an E-map, and sending the E-map to the PVR.

9. A PVR for tracking a mobile unit by a GPS system, the PVR comprising:
a CPU, which monitors and processes signals of the PVR;
a SDRAM, which stores temporary commands when the CPU compiling related programs;
a memory, which is an accessible and erasable hard disk for storing programs and IDs of a plurality of mobile unit;
a GPS processor, which processes the signals with special protocol from a master control station;
a modem, which modulates the input signals and demodulates the output signals;
an user-interface processor, which shows a menu with different functions of the CPU;
an output interface, which outputs image signals;
an IR receiver, which receives control signals from a remote user; and
an IR processor, which processes the control signals and transmits a signal to the CPU to process.

10. The PVR system of claim 9, wherein the output interface is a TV.

11. A method for a PVR to track a mobile unit by a GPS system, the method comprising the following steps:
(a) starting a tracking function of the GPS system;
(b) processing the tracking function by a CPU;
(c) identifying that the PVR connected with a master control station to get position data of the mobile unit;
(d) providing an ID of the mobile unit;
(e) identifying if the mobile unit starts, the master control station identifying that the ID of the mobile unit is stored in a data base according to the entered ID;
(f) getting the position data of the mobile unit, the position data of the mobile unit is downloaded to the PVR from the master control station; and
(g) identifying that the PVR disconnects the master control station.

12. The method of claim 11, wherein in the (a) step, the user utilizes a remote controller to send a starting signal to the PVR.

13. The method of claim 11, wherein in the (c) step, if the PVR doesn't connect with the master control station, the program will stop.

14. The method of claim 11, wherein in the (e) step, if the data base doesn't have the information of the tracked mobile unit, the master control station identifies that the PVR connects to the master control station again.

15. The method of claim 11, wherein in the (g) step, if the PVR still connects with the master control station, the method has to return to the F step.

16. The method of claim 11, wherein after the (g) step, the method further comprising the following steps:
(g1) downloading an appropriate E-map from a memory according to the position data of the mobile unit;
(g2) marking the coordinates of the mobile unit on the E-map; and
(3) displaying the E-map with the coordinates of the mobile unit in an output interface.

17. A method for identifying an ID of a mobile unit tracked by a GPS system used in a PVR, the method comprising the following steps:
(a) starting a tracking function of the GPS system;
(b) entering an ID of a desired mobile unit;
(c) identifying that there is no additional IDs of the mobile unit which needs to be tracked;
(d) identifying the ID of the mobile unit by the master control station;
(e) identifying that the mobile unit corresponding to the ID starts; and
(f) getting the position data of the mobile unit.

18. The method of claim 17, wherein in the step (c), if the user wants to track other mobile units at the same time, the procedure returns to the step B and the user enters other desired IDs.

19. The method of claim 17, wherein in the step (E), if the mobile unit doesn't start, the procedure returns to the step (b).

20. A method for getting position data of a mobile unit tracked by a GPS system used in a PVR, the method comprising the following steps:
(a) starting a GPS function;
(b) tracking at least one GPS satellite by a transceiver;
(c) identifying that the transceiver tracks more than three GPS satellites;
(d) receiving the signals transmitted from each of the GPS satellites; and
(e) computing the position data from the received signals.

21. The method of claim 20, wherein in the (c) step, if the transceiver doesn't track more than three GPS satellites, the procedure returns to the step (b).

22. The method of claim 20, wherein in the (d) step, the transceiver receives the signals from the tracked GPS satellites.

23. The method of claim 20, wherein in the (e) step, the position data is computed by the signals transmitted from each of the GPS satellites.

24. The method of claim 20, wherein after the (e) step, the method further comprising the following steps:
(f) outputting the position data and the ID of the mobile unit to a local area satellite;
(g) identifying and transmitting the position data;
(h) identifying that the GPS function is closed; and
(i) the mobile unit stopping the connection with the GPS satellites and the local area satellite.

25. The method of claim 24, wherein at the (g) step, the local area satellite identifies that the signals belongs to the position data, and then transmits the position data to a master control station.

26. The method of claim 24, wherein at the (h) step, if the user doesn't turn off the GPS function of the mobile unit, the procedure returns to the (d) step.
